(19) United States
(12) Patent Application Publication
(10) Pub. No.: US 2026/0179563 A1
(43) Pub. Date: Jun. 25, 2026

(54) DRIVING MODULE, DISPLAY PANEL AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Ziyang YU, Beijing (CN); Ming HU, Beijing (CN); Zhiliang JIANG, Beijing (CN); Qingqing YAN, Beijing (CN); Quanyong GU, Beijing (CN); Wenbo CHEN, Beijing (CN)

(73) Assignees: CHENGDU BOE OPTOELECTRONICS TECHNOLOGY CO., LTD., Chengdu, Sichuan (CN); BOE TECHNOLOGY GROUP CO., LTD., Beijing (CN)

(21) Appl. No.: 18/729,253

(22) PCT Filed: Oct. 17, 2023
(86) PCT No.: PCT/CN2023/124955

§ 371 Date: Jul. 16, 2024

(51) Int. Cl. G09G 3/3266; G09G 3/3233

(52) U.S. Cl. CPC G09G 3/3266; G09G 3/3233; G09G 2300/0819; G09G 2300/0842; G09G 2300/0861; G09G 2310/0286; G09G 2310/04; G09G 2310/08; G09G 2320/0257; G09G 2330/021

(57) ABSTRACT

A driving module, a display panel and a display device are provided. The driving module includes N driving units, N is an integer greater than 1; a first driving unit includes a first driving unit circuit, a gating unit circuit and a first output unit circuit; the gating unit circuit is configured to provide a gating control signal according to the first driving signal and a gating input signal; the first output unit circuit is configured to control whether to output the first driving signal to the pixel circuit in a current display period; an nth driving unit includes an nth driving unit circuit and an nth output unit circuit, n is an integer greater than 1 and less than or equal to N; an nth output unit circuit is configured to control whether to output the nth driving signal to the pixel circuit in the current display period according to the gating control signal.

### TECHNICAL FIELD

The present disclosure relates to the field of display technology, in particular to a driving module, a display panel and a display device.

### BACKGROUND

In the related art, the driving module may include at least two driving units; each driving unit may include a driving unit circuit, a gating unit circuit and an output unit circuit, the driving unit circuit is configured to provide a driving signal, the gating unit circuit is configured to provide a gating control signal according to the driving signal and the gating input signal, and the output unit circuit controls whether to output the driving signal to the pixel circuit in the current display period according to the gating control signal to achieve the update of the local screen image. In the related art, each driving unit needs to be provided with a gating unit circuit and an independent gating input signal, and the independent gating input signal cooperates with the respective driving units to control whether to output the corresponding driving signal to the pixel circuit to achieve accurate control of the output of the driving signal. The related driving module can realize the control of the update of the local screen image, but the number of devices and gating input signals is large, which greatly increases the occupied border and IC (integrated circuit) development difficulty.

### SUMMARY

In one aspect, the present disclosure provides in some embodiments a driving module, included in a display panel and for providing a driving signal for a pixel circuit in the display panel; wherein the driving module includes N driving units, N is an integer greater than 1; a first driving unit includes a first driving unit circuit, a gating unit circuit and a first output unit circuit; the first driving unit circuit is configured to provide a first driving signal; the gating unit circuit is electrically connected to the first driving unit circuit and a gating input signal terminal respectively, and is configured to provide a gating control signal according to the first driving signal and a gating input signal provided by the gating input signal terminal; the first output unit circuit is electrically connected to the first driving unit circuit, and is configured to control whether to output the first driving signal to the pixel circuit in a current display period according to the gating control signal; an nth driving unit includes an nth driving unit circuit and an nth output unit circuit, n is an integer greater than 1 and less than or equal to N; the nth driving unit circuit is configured to provide an nth driving signal; an nth output unit circuit is electrically connected to the nth driving unit circuit, and is configured to control whether to output the nth driving signal to the pixel circuit in the current display period according to the gating control signal.

Optionally, the first driving unit further comprises a storage unit circuit; the storage unit circuit is electrically connected to the gating unit circuit and configured to store the gating control signal; the first output unit circuit and the nth output unit circuit are also electrically connected to the storage unit circuit, is configured to receive the gating control signal.

Optionally, the first driving unit circuit includes M stages of first driving circuits, and an mth stage of first driving circuit is configured to provide an mth stage of first driving signal; M is an integer greater than 1; m is a positive integer less than or equal to M; the gating unit circuit includes M gating circuits; the first output unit circuit includes M first output circuits; an mth gating circuit is electrically connected to the mth stage of first driving circuit and the gating input signal terminal, respectively, and is configured to provide an mth gating control signal according to the mth stage of first driving signal provided by the mth stage of first driving circuit and the gating input signal provided by the gating input signal terminal; an mth first output circuit is electrically connected to the mth stage of first driving circuit, configured to control whether to output the mth stage of first driving signal to the pixel circuit in the current display period according to the mth gating control signal; the nth driving unit includes an nth driving unit circuit and an nth output unit circuit, n is an integer greater than 1 and less than or equal to N; the nth driving unit circuit includes M stages of nth driving circuits, and an mth stage of nth driving circuit is configured to provide an mth stage of nth driving signal; the nth output unit circuit includes M nth output circuits; an mth nth output circuit is electrically connected to the mth stage of nth driving circuit, and is configured to control whether to output the mth stage of nth driving signal to the pixel circuit in the current display period according to the mth gating control signal.

Optionally, the storage unit circuit includes M storage circuits; an mth storage circuit is electrically connected to the mth gating circuit, is configured to store the mth gating control signal; an mth first output circuit and an mth nth output circuit are also electrically connected to the mth storage circuit, is configured to receive the mth gating control signal.

In a second aspect, an embodiment of the present disclosure provides a display panel, including a pixel circuit and the driving module; wherein the pixel circuit is arranged in the display area.

Optionally, the driving module is arranged on a first side or a second side of the display area; the first side and the second side are opposite sides.

Optionally, the display panel comprises a first driving module and a second driving module; the first driving module is arranged on a first side of the display panel, and the second driving module is arranged on a second side of the display panel; the first side and the second side are opposite sides.

Optionally, the first driving module includes a first first driving unit and a second driving unit, and the second driving module includes a second first driving unit and a third driving unit; the first first driving unit is configured to control to output a first first driving signal; the second first driving unit is configured to control to output a second first driving signal; the second driving unit is configured to provide a second driving signal; and the third driving unit is configured to control to output a third driving signal.

Optionally, the first first driving unit includes a first first driving unit circuit, a first gating unit circuit and a first first output unit circuit; the first first driving unit circuit is configured to provide a first first driving signal; the first gating unit circuit is electrically connected to the first first driving unit circuit and the first gating input signal terminal respectively, and is configured to provide a first gating control signal according to the first first driving signal and the first gating input signal provided by the first gating input signal terminal; the first first output unit circuit is electrically connected to the first first driving unit circuit, and is configured to control whether to output the first first driving signal to the pixel circuit in the current display period according to the first gating control signal; the second driving unit includes a second driving unit circuit and a second output unit circuit; the second driving unit circuit is configured to provide a second driving signal; the second output unit circuit is electrically connected to the second driving unit circuit, and is configured to control whether to output the second driving signal to the pixel circuit in the current display period according to the first gating control signal.

Optionally, the first first driving unit further includes a first storage unit circuit; the first storage unit circuit is electrically connected to the first gating unit circuit and configured to store the first gating control signal; the second output unit circuit is electrically connected to the first storage unit circuit and configured to receive the first gating control signal.

Optionally, the second first driving unit includes a second first driving unit circuit, a second gating unit circuit and a second first output unit circuit; the second first driving unit circuit is configured to provide a second first driving signal; the second gating unit circuit is electrically connected to the second first driving unit circuit and the second gating input signal terminal respectively, and is configured to provide a second gating control signal according to the second first driving signal and the second gating input signal provided by the second gating input signal terminal; the second first output unit circuit is electrically connected to the second first driving unit circuit, and is configured to control whether to output the second first driving signal to the pixel circuit in the current display period according to the second gating control signal; the third driving unit includes a third driving unit circuit and a third output unit circuit; the third driving unit circuit is configured to provide a third driving signal; the third output unit circuit is electrically connected to the third driving unit circuit, and is configured to control whether to output the third driving signal to the pixel circuit in the current display period according to the second gating control signal.

Optionally, the second first driving unit further includes a second storage unit circuit; the second storage unit circuit is electrically connected to the second gating unit circuit and configured to store the second gating control signal; the third output unit circuit is electrically connected to the second storage unit circuit and configured to receive the second gating control signal.

Optionally, the pixel circuit includes a light emitting element, a display driving sub-circuit, a compensation control sub-circuit, a writing-in sub-circuit, a first initialization sub-circuit, a second initialization sub-circuit and a third initialization sub-circuit; a control terminal of the display driving sub-circuit is electrically connected to a first node, a first terminal of the display driving sub-circuit is electrically connected to a second node, and a second terminal of the display driving sub-circuit is electrically connected to a third node; the compensation control sub-circuit is electrically connected to the first driving control terminal, the first node and the third node respectively, and is configured to control to connect the first node and the third node under the control of the first driving control signal provided by the first driving control terminal; the writing-in sub-circuit is electrically connected to the second driving control terminal, the data line and the second node respectively, and is configured to write the data voltage provided by the data line into the second node under the control of the second driving control signal provided by the second driving control terminal; the first initialization sub-circuit is electrically connected to the first reset control terminal, the first initial voltage terminal and the third node respectively, and is configured to write the first initial voltage provided by the first initial voltage terminal into the third node under the control of the first reset control signal provided by the first reset control terminal; the second initialization sub-circuit is electrically connected to the second reset control terminal, the second initial voltage terminal and the second node respectively, and is configured to write the second initial voltage provided by the second initial voltage terminal into the second node under the control of the second reset control signal provided by the second reset control terminal; the third initialization sub-circuit is electrically connected to the second reset control terminal, the third initial voltage terminal and the first electrode of the light emitting element respectively, and is configured to write the third initial voltage provided by the third initial voltage terminal into a first electrode of the light emitting element under the control of the second reset control signal; a second electrode of the light emitting element is electrically connected to the first voltage terminal.

Optionally, the second initialization sub-circuit is configured to control to write the second initial voltage into the second node before the first initialization sub-circuit writes the first initial voltage provided by the first initial voltage terminal into the third node and the compensation control sub-circuit controls to connect the first node and the third node under the control of the second reset control signal; the third initialization sub-circuit is configured to control to write the third initial voltage into the first electrode of the light emitting element before the first initialization sub-circuit writes the first initial voltage provided by the first initial voltage terminal into the third node and the compensation control sub-circuit controls to connect the first node and the third node under the control of the second reset control signal.

Optionally, the pixel circuit further includes a first light emitting control sub-circuit and a second light emitting control sub-circuit; the first light emitting control sub-circuit is electrically connected to a light emitting control terminal, a power supply voltage terminal and the second node respectively, and is configured to control to connect the power supply voltage terminal and the second node under the control of a light emitting control signal provided by the light emitting control terminal; the second light emitting control sub-circuit is electrically connected to the light emitting control terminal, the third node and the first electrode of the light emitting element respectively, and is configured to control to connect the third node and the first electrode of the light emitting element under the control of the light emitting control signal; or, the first light emitting control sub-circuit is electrically connected to the light emitting control terminal, the power supply voltage terminal and the third node respectively, and is configured to control to connect the power supply voltage terminal and the third node under the control of the light emitting control signal provided by the light emitting control terminal; the second light emitting control sub-circuit is electrically connected to the light emitting control terminal, the second node and the first electrode of the light emitting element respectively, and is configured to control to connect the second node and the first electrode of the light emitting element under the control of the light emitting control signal.

Optionally, the display driving sub-circuit includes a driving transistor, the first initialization sub-circuit includes a first transistor, the compensation control sub-circuit includes a second transistor, the writing-in sub-circuit includes a third transistor, the second initialization sub-circuit includes a fourth transistor, and the third initialization sub-circuit includes a fifth transistor; a gate electrode of the driving transistor is electrically connected to the first node, a first electrode of the driving transistor is electrically connected to the second node, and a second electrode of the driving transistor is electrically connected to the third node; a gate electrode of the first transistor is electrically connected to the first reset control terminal, a first electrode of the first transistor is electrically connected to the first initial voltage terminal, and a second electrode of the first transistor is electrically connected to the third node; a gate electrode of the second transistor is electrically connected to the first driving control terminal, a first electrode of the second transistor is electrically connected to the first node, and a second electrode of the second transistor is electrically connected to the third node; a gate electrode of the third transistor is electrically connected to the second driving control terminal, a first electrode of the third transistor is electrically connected to the data line, and a second electrode of the third transistor is electrically connected to the second node; a gate electrode of the fourth transistor is electrically connected to the second reset control terminal, a first electrode of the fourth transistor is electrically connected to the second initial voltage terminal, and a second electrode of the fourth transistor is electrically connected to the second node; a gate electrode of the fifth transistor is electrically connected to the second reset control terminal, a first electrode of the fifth transistor is electrically connected to the third initial voltage terminal, and a second electrode of the fifth transistor is electrically connected to the first electrode of the light emitting element.

Optionally, the first transistor is a p-type transistor and the second transistor is an n-type transistor; or, the first transistor is an n-type transistor and the second transistor is a p-type transistor.

Optionally, the first transistor and the second transistor are both n-type transistors, or, the first transistor and the second transistor are both p-type transistors.

Optionally, a same driving unit included in the driving module provides a first driving control signal for the first driving control terminal and provides a first reset control signal for the first reset control terminal.

Optionally, the driving module includes two driving units for providing the first driving control signal, and two driving units for providing the second driving control signal; one driving unit for providing the first driving control signal and one driving unit for providing the second driving control signal are arranged on a first side of the display area; the other driving unit for providing the first driving control signal and the other driving unit for providing the second driving control signal are arranged on a second side of the display area; the first side and the second side are opposite sides.

Optionally, the display panel further includes a driving unit for providing the second reset control signal, and a driving unit for providing the light emitting control signal; the driving unit for providing the second reset control signal is arranged on a first side of the display area; the driving unit for providing the light emitting control signal is arranged on a second side of the display area.

In a third aspect, an embodiment of the present disclosure provides a display device including the display panel.

### BRIEF DESCRIPTION OF THE DRAWINGS

FIG. 1 is a structural diagram of a driving module according to at least one embodiment of the present disclosure;

FIG. 2 is a structural diagram of a driving module according to at least one embodiment of the present disclosure;

FIG. 3 is a structural diagram of a pixel circuit according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a circuit diagram of a pixel circuit according to at least one embodiment of the present disclosure;

FIG. 7 is a circuit diagram of a pixel circuit according to at least one embodiment of the present disclosure;

FIG. 8 is a timing diagram of the pixel circuit shown in FIG. 6;

FIG. 9 is a timing diagram of the pixel circuit shown in FIG. 6;

FIG. 10 is a circuit diagram of a pixel circuit according to at least one embodiment of the present disclosure

FIG. 11 is a circuit diagram of a pixel circuit according to at least one embodiment of the present disclosure;

FIG. 12 is a timing diagram of the pixel circuit shown in FIG. 10;

FIG. 13 is a timing diagram of the pixel circuit shown in FIG. 10;

FIG. 14 is a circuit diagram of a pixel circuit according to at least one embodiment of the present disclosure;

FIG. 15 is a circuit diagram of a pixel circuit according to at least one embodiment of the present disclosure;

FIG. 16 is a structural diagram of a display panel according to at least one embodiment of the present disclosure;

FIG. 17 is a structural diagram of a display panel according to at least one embodiment of the present disclosure;

FIG. 18 is a structural diagram of a display panel according to at least one embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. Based on the embodiments in the present disclosure, all other embodiments obtained by those of ordinary skill in the art without making creative efforts fall within the scope of protection of the present disclosure.

The transistors used in all embodiments of the present disclosure may be thin film transistors, field effect transistors, or other devices with the same characteristics. In the embodiment of the present disclosure, in order to distinguish the two electrodes of the transistor except the gate electrode, one electrode is called the first electrode and the other electrode is called the second electrode.

In actual operation, when the transistor is a thin film transistor or a field effect transistor, the first electrode may be a drain electrode, and the second electrode may be a source electrode; or, the first electrode may be a source electrode, the second electrode may be a drain electrode.

The driving module described in the embodiment of the present disclosure is included in the display panel, and is configured to provide a driving signal for the pixel circuit in the display panel; the driving module includes N driving units, N is an integer greater than 1;

The first driving unit includes a first driving unit circuit, a gating unit circuit and a first output unit circuit;

The first driving unit circuit is configured to provide a first driving signal;

The gating unit circuit is electrically connected to the first driving unit circuit and the gating input signal terminal respectively, and is configured to provide a gating control signal according to the first driving signal and a gating input signal provided by the gating input signal terminal;

The first output unit circuit is electrically connected to the first driving unit circuit, and is configured to control whether to output the first driving signal to the pixel circuit in the current display period according to the gating control signal;

The nth driving unit includes an nth driving unit circuit and an nth output unit circuit, n is an integer greater than 1 and less than or equal to N;

The nth driving unit circuit is configured to provide an nth driving signal;

The nth output unit circuit is electrically connected to the nth driving unit circuit, and is configured to control whether to output the nth driving signal to the pixel circuit in the current display period according to the gating control signal.

In the driving module described in the embodiment of the present disclosure, the first driving unit is set to include a gating unit circuit, while the other driving units included in the driving module does not include a gating unit circuit. The gating control signal generated by the gating unit circuit in the first driving unit is configured to control whether the driving units other than the first driving unit in the driving module output corresponding driving signals to the pixel circuit. Under the premise of realizing the control of the local screen update, the number of devices and gating input signals used can be reduced, and the occupied border and IC development difficulty can be reduced.

In at least one embodiment of the present disclosure, the first driving unit also includes a storage unit circuit;

The storage unit circuit is electrically connected to the gating unit circuit for storing the gating control signal;

The first output unit circuit and the nth output unit circuit are also electrically connected to the storage unit circuit for receiving the gating control signal.

In specific implementation, the first driving unit may also include a storage unit circuit, the storage unit circuit stores the gating control signal, and each output unit circuit receives the gating control signal from the storage unit circuit. In at least one embodiment of the present disclosure, only the first driving unit is provided with a storage unit circuit, and the driving units other than the first driving unit included in the driving module are not provided with a storage unit circuit, so as to reduce the number of devices and help reduce the occupied frame.

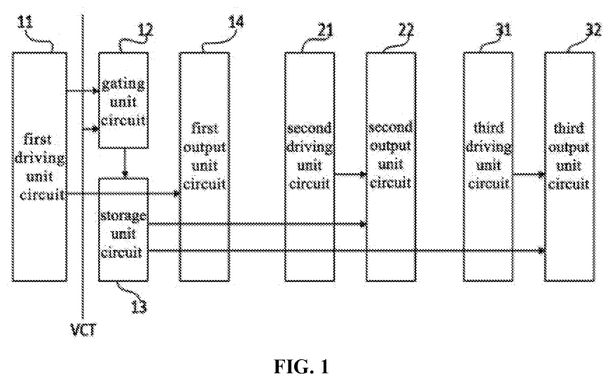

As shown in FIG. 1, the driving module described in at least one embodiment of the present disclosure is included in a display panel, and is configured to provide a driving signal for a pixel circuit in the display panel; the driving module includes a first driving unit, a second driving unit and a third driving unit;

The first driving unit includes a first driving unit circuit 11, a gating unit circuit 12, a storage unit circuit 13 and a first output unit circuit 14;

The first driving unit circuit 11 is configured to provide a first driving signal;

The gating unit circuit 12 is electrically connected to the first driving unit circuit 11 and the gating input signal terminal VCT respectively, and is configured to provide a gating control signal according to the first driving signal and the gating input signal provided by the gating input signal terminal VCT;

The storage unit circuit 13 is electrically connected to the gating unit circuit 12, and is configured to store the gating control signal;

The first output unit circuit 14 is electrically connected to the first driving unit circuit 11 and the storage unit circuit 13 respectively, and is configured to receive the gating control signal from the storage unit circuit 13, and control whether to output the first driving signal to the pixel circuit in the current display period according to the gating control signal;

The second driving unit includes a second driving unit circuit 21 and a second output unit circuit 22;

The second driving unit circuit 21 is configured to provide a second driving signal;

The second output unit circuit 22 is electrically connected to the second driving unit circuit 21 and the storage unit circuit 13, respectively, is configured to receive the gating control signal from the storage unit circuit 13, and control whether to output the second driving signal to the pixel circuit in the current display period according to the gating control signal;

The third driving unit includes a third driving unit circuit 31 and a third output unit circuit 32;

The third driving unit circuit 31 is configured to provide a third driving signal;

The third output unit circuit 32 is electrically connected to the third driving unit circuit 31 and the storage unit circuit 13, respectively, is configured to receive the gating control signal from the storage unit circuit 13, and control whether to output the third driving signal to the pixel circuit in the current display period according to the gating control signal.

In at least one embodiment of the present disclosure, the first driving unit circuit includes M stages of first driving circuits, and the mth stage of first driving circuit is configured to provide the mth stage of first driving signal; M is an integer greater than 1; m is a positive integer less than or equal to M;

The gating unit circuit includes M gating circuits; the first output unit circuit includes M first output circuits;

The mth gating circuit is electrically connected to the mth stage of first driving circuit and the gating input signal terminal, respectively, and is configured to provide the mth gating control signal according to the mth stage of first driving signal provided by the mth stage of first driving circuit and the gating input signal provided by the gating input signal terminal;

The mth first output circuit is electrically connected to the mth stage of first driving circuit, configured to control whether to output the mth stage of first driving signal to the pixel circuit in the current display period according to the mth gating control signal;

The nth driving unit includes the nth driving unit circuit and the nth output unit circuit, n is an integer greater than 1 and less than or equal to N;

The nth driving unit circuit includes M stages of nth driving circuits, and the mth stage of nth driving circuit is configured to provide the mth stage of nth driving signal;

The nth output unit circuit includes M nth output circuits;

The mth nth output circuit is electrically connected to the mth stage of nth driving circuit, and is configured to control whether to output the mth stage of nth driving signal to the pixel circuit in the current display period according to the mth gating control signal.

In a specific implementation, the first driving unit circuit may include M stages of first driving circuits, the mth stage of first driving circuit provides the mth stage of first driving signal, the gating unit circuit may include M gating circuits, and the first output unit circuit includes M first output circuits; the mth gating circuit provides the mth gating control signal according to the mth stage of first driving signal and the gating input signal, and the mth first output circuit controls whether to output the mth stage of first driving signal to the pixel circuit in the current display period according to the mth gating control signal; the mth nth output circuit controls whether to output the mth stage of nth driving signal to the pixel circuit in the current display period according to the mth gating control signal.

Optionally, the storage unit circuit includes M storage circuits;

The mth storage circuit is electrically connected to the mth gating circuit for storing the mth gating control signal;

The mth first output circuit and the mth nth output circuit are also electrically connected to the mth storage circuit for receiving the mth gating control signal.

In a specific implementation, the storage unit circuit may include M storage circuits; the mth storage circuit stores the mth gating control signal; the mth first output circuit and the mth nth output circuit receive the mth gating control signal.

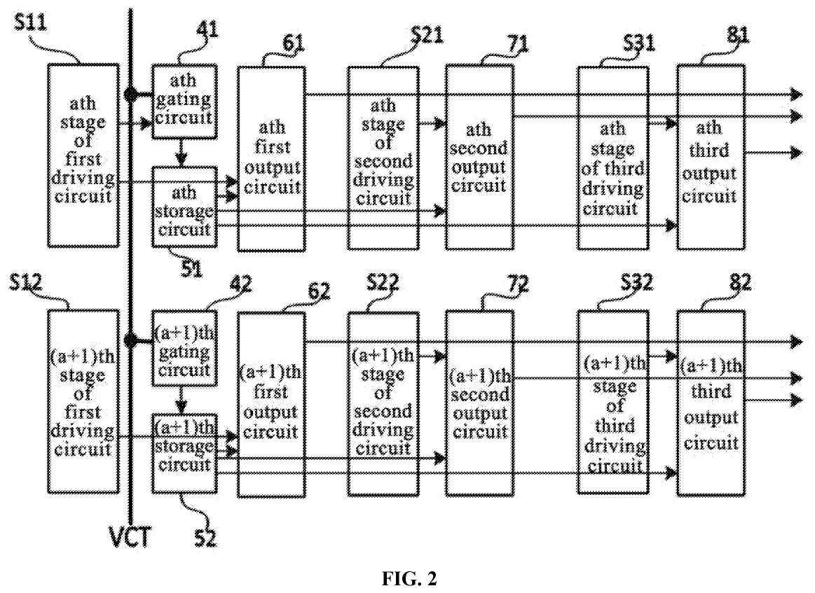

As shown in FIG. 2, based on at least one embodiment of the driving module shown in FIG. 1, the first driving unit circuit includes an ath stage of first driving circuit S11 and the (a+1)th stage of first driving circuit S12; a is a positive integer;

The gating unit circuit includes the ath gating circuit 41 and the (a+1)th gating circuit 42;

The storage unit circuit includes the ath storage circuit 51 and the (a+1)th storage circuit 52;

The first output unit circuit includes the ath first output circuit 61 and the (a+1)th first output circuit 62;

The second driving unit circuit includes the ath stage of second driving circuit S21 and the (a+1)th stage of second driving circuit S22;

The second output unit circuit includes the ath second output circuit 71 and the (a+1)th second output circuit 72;

The third driving unit circuit includes the ath stage of third driving circuit S31 and the (a+1)th stage of third driving circuit S32;

The third output unit circuit includes the ath third output circuit 81 and the (a+1)th third output circuit 82;

The ath stage of first driving circuit S11 is configured to provide the ath stage of first driving signal; the (a+1)th stage of first driving circuit S12 is configured to provide the (a+1)th stage of first driving signal;

The ath gating circuit 41 is electrically connected to the ath stage of first driving circuit S11 and the gating input signal terminal VCT respectively, and is configured to provide the ath gating control signal according to the ath stage of first driving signal and the gating input signal provided by the gating input signal terminal VCT;

The ath storage circuit 51 is electrically connected to the ath gating circuit 41, and is configured to store the ath gating control signal;

The ath first output circuit 61 is electrically connected to the ath storage circuit 51 and the ath stage of first driving circuit S11 to receive the ath gating control signal from the ath storage circuit 51, and controls whether to output the ath stage of first driving signal to the pixel circuit according to the ath gating control signal;

The (a+1)th gating circuit 42 is electrically connected to the (a+1)th stage of first driving circuit S12 and the gating input signal terminal VCT respectively, and is configured to provide the (a+1)th gating control signal according to the (a+1)th stage of first driving signal and the gating input signal provided by the gating input signal terminal VCT; The (a+1)th first driving circuit 52 is electrically connected to the (a+1)th gating circuit 42, and is configured to store the (a+1)th gating control signal;

The (a+1)th first output circuit 62 is electrically connected to the (a+1)th storage circuit 52 and the (a+1)th stage of first driving circuit S12, respectively, and is configured to receive the (a+1)th gating control signal from the (a+1)th storage circuit 52, and control whether to output the (a+1)th stage of first driving signal to the pixel circuit according to the (a+1)th gating control signal;

The ath stage of second driving circuit S21 is configured to provide the ath stage of second driving signal; (a+1)th stage of second driving circuit S22 is configured to provide(a+1) th stage of second driving signal;

The ath second output circuit 71 is electrically connected to ath stage of second driving circuit S21 and ath storage circuit 51, and is configured to receive the ath gating control signal from the ath storage circuit 51, and control whether to output the ath stage of second driving signal to the pixel circuit according to the ath gating control signal;

The (a+1)th second output circuit 72 is electrically connected to (a+1)th stage of second driving circuit S22 and (a+1)th storage circuit 52 to receive the (a+1)th gating control signal from the (a+1)th storage circuit 52, and controls whether to output the (a+1)th stage of second driving signal to the pixel circuit according to the (a+1)th gating control signal;

the ath stage of third driving circuit S31 is configured to provide the ath stage of third driving signal; the (a+1)th stage of third driving circuit S32 is configured to provide the (a+1)th stage of third driving signal;

the ath third output circuit 81 is electrically connected to the ath stage of third driving circuit S31 and the ath storage circuit 51, respectively, to receives the ath gating control signal from the ath storage circuit 51, and controls whether to output the ath stage of third driving signal to the pixel circuit according to the ath gating control signal;

The (a+1)th third output circuit 82 is electrically connected to the (a+1)th stage of third driving circuit S32 and the (a+1)th storage circuit 52, respectively, is configured to receive the (a+1)th gating control signal from the (a+1)th storage circuit 52, and controls whether to output the (a+1)th stage of third driving signal to the pixel circuit according to the (a+1)th gating control signal.

The display panel described in the embodiment of the present disclosure includes a pixel circuit and the above-mentioned driving module;

The pixel circuit is arranged in the display area.

In at least one embodiment of the present disclosure, the driving module is arranged on the first side or the second side of the display area;

The first side and the second side are opposite sides.

In specific implementation, the driving module can be arranged on one side, that is, the driving module can be arranged on the first side or the second side of the display area.

Optionally, the first side may be a left side, and the second side may be a right side, but not limited thereto.

In at least one embodiment of the present disclosure, the display panel includes a first driving module and a second driving module;

The first driving module is arranged on the first side of the display panel, and the second driving module is arranged on the second side of the display panel;

The first side and the second side are opposite sides.

In a specific implementation, the driving module may be arranged on both sides, that is, the first driving module and the second driving module included in the display panel may be arranged on opposite sides of the display panel, respectively.

Optionally, the first driving module includes a first first driving unit and a second driving unit, and the second driving module includes a second first driving unit and a third driving unit;

The first first driving unit is configured to control the output of a first first driving signal;

The second first driving unit is configured to control the output of a second first driving signal;

The second driving unit is configured to provide a second driving signal; and the third driving unit is configured to control the output of a third driving signal.

In at least one embodiment of the present disclosure, the first first driving signal may be a first driving control signal, the second first driving signal may be a first reset control signal, the second driving signal may be a first second driving control signal, and the third driving signal may be a second second driving control signal, but is not limited thereto.

In at least one embodiment of the present disclosure, the first first driving unit includes a first first driving unit circuit, a first gating unit circuit and a first first output unit circuit;

The first first driving unit circuit is configured to provide a first first driving signal;

The first gating unit circuit is electrically connected to the first first driving unit circuit and the first gating input signal terminal respectively, and is configured to provide a first gating control signal according to the first first driving signal and the first gating input signal provided by the first gating input signal terminal;

The first first output unit circuit is electrically connected to the first first driving unit circuit, and is configured to control whether to output the first first driving signal to the pixel circuit in the current display period according to the first gating control signal;

The second driving unit includes a second driving unit circuit and a second output unit circuit;

The second driving unit circuit is configured to provide a second driving signal;

The second output unit circuit is electrically connected to the second driving unit circuit, and is configured to control whether to output the second driving signal to the pixel circuit in the current display period according to the first gating control signal.

In a specific implementation, the first first driving unit may include a first first driving unit circuit, a first gating unit circuit and a first first output unit circuit; the first first driving unit circuit provides a first first driving signal; the first gating unit circuit provides a first gating control signal according to the first first driving signal and the first gating input signal; the first first output unit circuit controls whether to output the first first driving signal to the pixel circuit in the current display period according to the first gating control signal; the second driving unit circuit is configured to provide a second driving signal; the second output unit circuit controls whether to output the second driving signal to the pixel circuit in the current display period according to the first gating control signal.

Optionally, the first first driving unit further includes a first storage unit circuit;

The first storage unit circuit is electrically connected to the first gating unit circuit for storing the first gating control signal;

The second output unit circuit is electrically connected to the first storage unit circuit for receiving the first gating control signal.

In a specific implementation, the first first driving unit may also include a first storage unit circuit, the first storage unit circuit stores the first gating control signal, and the second output unit circuit receives the first gating control signal.

In at least one embodiment of the present disclosure, the second first driving unit includes a second first driving unit circuit, a second gating unit circuit and a second first output unit circuit;

The second first driving unit circuit is configured to provide a second first driving signal;

The second gating unit circuit is electrically connected to the second first driving unit circuit and the second gating input signal terminal respectively, and is configured to provide a second gating control signal according to the second first driving signal and the second gating input signal provided by the second gating input signal terminal;

The second first output unit circuit is electrically connected to the second first driving unit circuit, and is configured to control whether to output the second first driving signal to the pixel circuit in the current display period according to the second gating control signal;

The third driving unit includes a third driving unit circuit and a third output unit circuit;

The third driving unit circuit is configured to provide a third driving signal;

The third output unit circuit is electrically connected to the third driving unit circuit, and is configured to control whether to output the third driving signal to the pixel circuit in the current display period according to the second gating control signal.

In a specific implementation, the second first driving unit may include a second first driving unit circuit, a second gating unit circuit and a second first output unit circuit; the second first driving unit circuit provides a second first driving signal; the second gating unit circuit provides a second gating control signal according to the second first driving signal and the second gating input signal; the second first output unit circuit controls whether to output the second first driving signal to the pixel circuit in the current display period according to the second gating control signal; the third driving unit may include a third driving unit circuit and a third output unit circuit; the third driving unit circuit provides a third driving signal; the third output unit circuit controls whether to output the third driving signal to the pixel circuit in the current display period according to the second gating control signal.

Optionally, the second first driving unit also includes a second storage unit circuit;

The second storage unit circuit is electrically connected to the second gating unit circuit for storing the second gating control signal;

The third output unit circuit is electrically connected to the second storage unit circuit for receiving the second gating control signal.

In specific implementation, the second first driving unit may also include a second storage unit circuit; the second storage unit circuit stores the second gating control signal; the third output unit circuit receives the second gating control signal.

In at least one embodiment of the present disclosure, the pixel circuit includes a light emitting element, a display driving sub-circuit, a compensation control sub-circuit, a writing-in sub-circuit, a first initialization sub-circuit, a second initialization sub-circuit and a third initialization sub-circuit;

a control terminal of the display driving sub-circuit is electrically connected to a first node, a first terminal of the display driving sub-circuit is electrically connected to a second node, and a second terminal of the display driving sub-circuit is electrically connected to a third node;

The compensation control sub-circuit is electrically connected to the first driving control terminal, the first node and the third node respectively, and is configured to control to connect the first node and the third node under the control of the first driving control signal provided by the first driving control terminal;

The writing-in sub-circuit is electrically connected to the second driving control terminal, the data line and the second node respectively, and is configured to write the data voltage provided by the data line into the second node under the control of the second driving control signal provided by the second driving control terminal;

The first initialization sub-circuit is electrically connected to the first reset control terminal, the first initial voltage terminal and the third node respectively, and is configured to write the first initial voltage provided by the first initial voltage terminal into the third node under the control of the first reset control signal provided by the first reset control terminal;

The second initialization sub-circuit is electrically connected to the second reset control terminal, the second initial voltage terminal and the second node respectively, and is configured to write the second initial voltage provided by the second initial voltage terminal into the second node under the control of the second reset control signal provided by the second reset control terminal;

The third initialization sub-circuit is electrically connected to the second reset control terminal, the third initial voltage terminal and the first electrode of the light emitting element respectively, and is configured to write the third initial voltage provided by the third initial voltage terminal into the first electrode of the light emitting element under the control of the second reset control signal;

The second electrode of the light emitting element is electrically connected to the first voltage terminal.

Optionally, the first voltage terminal can be a low voltage terminal.

In a specific implementation, the pixel circuit may include a light emitting element, a display driving sub-circuit, a compensation control sub-circuit, a writing-in sub-circuit, a first initialization sub-circuit, a second initialization sub-circuit and a third initialization sub-circuit; the compensation control sub-circuit controls to connect the first node and the third node under the control of the first driving control signal; the writing-in sub-circuit writes the data voltage provided by the data line to the second node under the control of the second driving control signal; the first initialization sub-circuit writes the first initial voltage to the third node under the control of the first reset control signal; the second initialization sub-circuit writes the second initial voltage to the second node under the control of the second reset control signal; the third initialization sub-circuit writes the third initial voltage to the first electrode of the light emitting element under the control of the second reset control signal.

Optionally, the second initialization sub-circuit is configured to control to write the second initial voltage into the second node before the first initialization sub-circuit writes the first initial voltage provided by the first initial voltage terminal into the third node and the compensation control sub-circuit controls to connect the first node and the third node under the control of the second reset control signal;

The third initialization sub-circuit is configured to control to write the third initial voltage into the first electrode of the light emitting element before the first initialization sub-circuit writes the first initial voltage provided by the first initial voltage terminal into the third node and the compensation control sub-circuit controls to connect the first node and the third node under the control of the second reset control signal.

In a specific implementation, the second initialization sub-circuit controls to write the second initial voltage into the second node under the control of the second reset control signal before the first initialization sub-circuit writes the first initial voltage provided by the first initial voltage terminal into the third node and the compensation control sub-circuit controls to connect the first node and the third node; the third initialization sub-circuit, under the control of the second reset control signal, controls to write the third initial voltage into the first electrode of the light emitting element before the first initialization sub-circuit writes the first initial voltage provided by the first initial voltage terminal into the third node and the compensation control sub-circuit controls to connect the first node and the third node, so as to improve the hysteresis phenomenon.

In at least one embodiment of the present disclosure, the pixel circuit further includes a first light emitting control sub-circuit and a second light emitting control sub-circuit;

The first light emitting control sub-circuit is electrically connected to the light emitting control terminal, the power supply voltage terminal and the second node respectively, and is configured to control to connect the power supply voltage terminal and the second node under the control of the light emitting control signal provided by the light emitting control terminal; the second light emitting control sub-circuit is electrically connected to the light emitting control terminal, the third node and the first electrode of the light emitting element respectively, and is configured to control to connect the third node and the first electrode of the light emitting element under the control of the light emitting control signal; or,

The first light emitting control sub-circuit is electrically connected to the light emitting control terminal, the power supply voltage terminal and the third node respectively, and is configured to control to connect the power supply voltage terminal and the third node under the control of the light emitting control signal provided by the light emitting control terminal; the second light emitting control sub-circuit is electrically connected to the light emitting control terminal, the second node and the first electrode of the light emitting element respectively, and is configured to control to connect the second node and the first electrode of the light emitting element under the control of the light emitting control signal.

In a specific implementation, the pixel circuit may further include a first light emitting control sub-circuit and a second light emitting control sub-circuit; the first light emitting control sub-circuit controls to connect the power supply voltage terminal and the second node under the control of the light emitting control signal; the second light emitting control sub-circuit controls to connect the third node and the first electrode of the light emitting element under the control of the light emitting control signal; or, the first light emitting control sub-circuit controls to connect the power supply voltage terminal and the third node under the control of the light emitting control signal; the second light emitting control sub-circuit controls to connect the second node and the first electrode of the light emitting element under the control of the light emitting control signal.

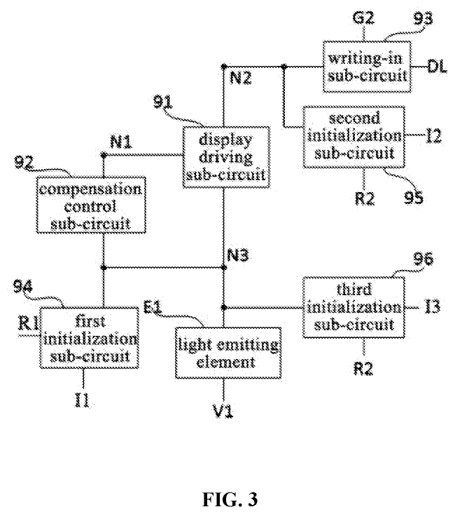

As shown in FIG. 3, at least one embodiment of the pixel circuit may include a light emitting element E1, a display driving sub-circuit 91, a compensation control sub-circuit 92, a writing-in sub-circuit 93, a first initialization sub-circuit 94, a second initialization sub-circuit 95 and a third initialization sub-circuit 96;

The control terminal of the display driving sub-circuit 91 is electrically connected to the first node N1, the first terminal of the display driving sub-circuit 91 is electrically connected to the second node N2, and the second terminal of the display driving sub-circuit 91 is electrically connected to the third node N3; the third node N3 is electrically connected to the first electrode of the light emitting element E1;

The compensation control sub-circuit 92 is electrically connected to the first driving control terminal G1, the first node N1 and the third node N3 respectively, and is configured to control to connect the first node N1 and the third node N3 under the control of the first driving control signal provided by the first driving control terminal G1;

The writing-in sub-circuit 93 is electrically connected to the second driving control terminal G2, the data line DL and the second node N2 respectively, and is configured to write the data voltage provided by the data line DL into the second node N2 under the control of the second driving control signal provided by the second driving control terminal G2;

The first initialization sub-circuit 94 is electrically connected to the first reset control terminal R1, the first initial voltage terminal I1 and the third node N3 respectively, and is configured to write the first initial voltage Vi1 provided by the first initial voltage terminal I1 into the third node N3 under the control of the first reset control signal provided by the first reset control terminal R1;

The second initialization sub-circuit 95 is electrically connected to the second reset control terminal R2, the second initial voltage terminal 12 and the second node N2 respectively, and is configured to write the second initial voltage Vi2 provided by the second initial voltage terminal 12 into the second node N2 under the control of the second reset control signal provided by the second reset control terminal R2;

The third initialization sub-circuit 96 is electrically connected to the second reset control terminal R2, the third initial voltage terminal 13 and the first electrode of the light emitting element E1 respectively, and is configured to write the third initial voltage Vi3 provided by the third initial voltage terminal 13 into the first electrode of the light emitting element E1 under the control of the second reset control signal;

The second electrode of the light emitting element E1 is electrically connected to the first voltage terminal V1.

In at least one embodiment of the present disclosure, the light emitting element E1 may be an organic light emitting diode, the first electrode of the light emitting element E1 may be an anode, and the second electrode of the light emitting element E1 may be a cathode, but not limited thereto.

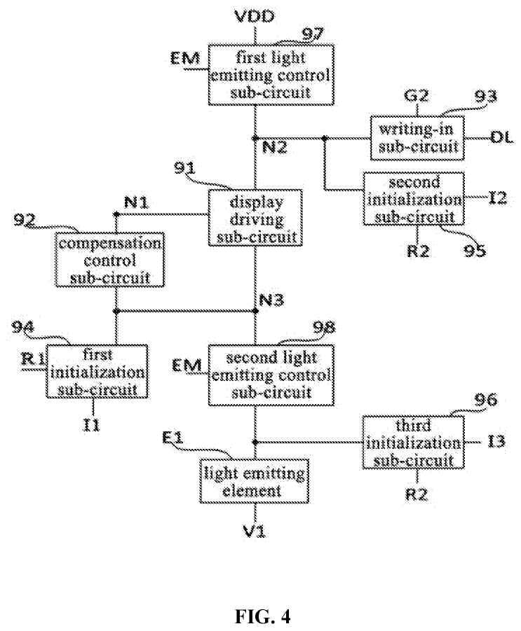

As shown in FIG. 4, based on at least one embodiment of the pixel circuit shown in FIG. 3, the pixel circuit further includes a first light emitting control sub-circuit 97 and a second light emitting control sub-circuit 98;

The first light emitting control sub-circuit 97 is electrically connected to the light emitting control terminal EM, the power supply voltage terminal VDD and the second node N2, respectively, and is configured to control to connect the power supply voltage terminal VDD and the second node N2 under the control of the light emitting control signal provided by the light emitting control terminal EM;

The second light emitting control sub-circuit 98 is electrically connected to the light emitting control terminal EM, the third node N3 and the first electrode of the light emitting element E1, respectively, and is configured to control to connect the third node N3 and the first electrode of the light emitting element E1 under the control of the light emitting control signal.

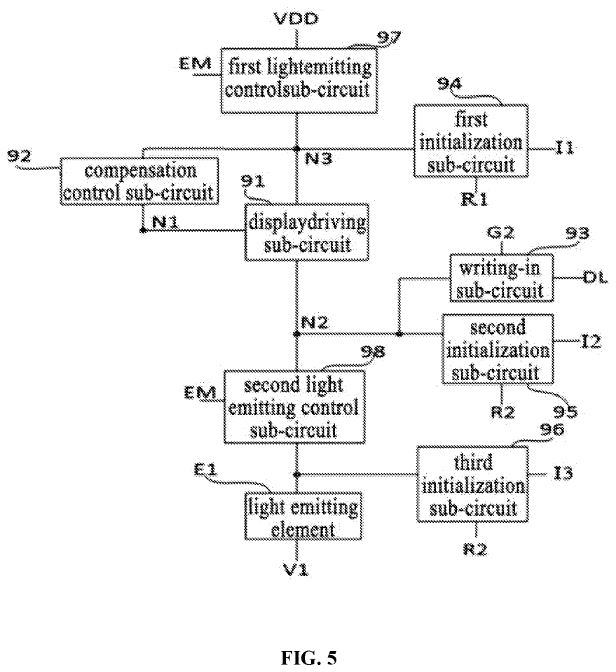

As shown in FIG. 5, at least one embodiment of the pixel circuit may include a light emitting element E1, a display driving sub-circuit 91, a compensation control sub-circuit 92, a writing-in sub-circuit 93, a first initialization sub-circuit 94, a second initialization sub-circuit 95, a third initialization sub-circuit 96, a first light emitting control sub-circuit 97, and a second light emitting control sub-circuit 98;

The first light emitting control sub-circuit 97 is electrically connected to the light emitting control terminal EM, the power supply voltage terminal VDD, and the third node N3, respectively, and is configured to control to connect the power supply voltage terminal VDD and the third node N3 under the control of the light emitting control signal provided by the light emitting control terminal EM;

The second light emitting control sub-circuit 98 is electrically connected to the light emitting control terminal EM, the second node N2 and the first electrode of the light emitting element E1, and are configured to control to connect the second node N2 and the first electrode of the light emitting element E1 under the control of the light emitting control signal;

The control terminal of the display driving sub-circuit 91 is electrically connected to the first node N1, the first terminal of the display driving sub-circuit 91 is electrically connected to the second node N2, and the second terminal of the display driving sub-circuit 91 is electrically connected to the third node N3;

The compensation control sub-circuit 92 is electrically connected to the first driving control terminal G1, the first node N1 and the third node N3 respectively, and is configured to control to connect the first node N1 and the third node N3 under the control of the first driving control signal provided by the first driving control terminal G1;

The writing-in sub-circuit 93 is electrically connected to the second driving control terminal G2, the data line DL and the second node N2 respectively, and is configured to write the data voltage provided by the data line DL into the second node N2 under the control of the second driving control signal provided by the second driving control terminal G2;

The first initialization sub-circuit 94 is electrically connected to the first reset control terminal R1, the first initial voltage terminal I1 and the third node N3 respectively, and is configured to write the first initial voltage Vi1 provided by the first initial voltage terminal I1 into the third node N3 under the control of the first reset control signal provided by the first reset control terminal R1;

The second initialization sub-circuit 95 are respectively electrically connected to the second reset control terminal R2, the second initial voltage terminal 12 and the second node N2, and is configured to write the second initial voltage Vi2 provided by the second initial voltage terminal I2 into the second node N2 under the control of the second reset control signal provided by the second reset control terminal R2;

The third initialization sub-circuit 96 is respectively electrically connected to the second reset control terminal R2, the third initial voltage terminal I3 and the first electrode of the light emitting element E1, and is configured to write the third initial voltage Vi3 provided by the third initial voltage terminal I3 into the first electrode of the light emitting element E1 under the control of the second reset control signal;

The second electrode of the light emitting element E1 is electrically connected to the first voltage terminal V1.

Optionally, the first voltage terminal can be a low voltage terminal.

Optionally, the display driving sub-circuit includes a driving transistor, the first initialization sub-circuit includes a first transistor, the compensation control sub-circuit includes a second transistor, the writing-in sub-circuit includes a third transistor, the second initialization sub-circuit includes a fourth transistor, and the third initialization sub-circuit includes a fifth transistor;

a gate electrode of the driving transistor is electrically connected to the first node, a first electrode of the driving transistor is electrically connected to the second node, and a second electrode of the driving transistor is electrically connected to the third node;

a gate electrode of the first transistor is electrically connected to the first reset control terminal, a first electrode of the first transistor is electrically connected to the first initial voltage terminal, and a second electrode of the first transistor is electrically connected to the third node;

a gate electrode of the second transistor is electrically connected to the first driving control terminal, a first electrode of the second transistor is electrically connected to the first node, and a second electrode of the second transistor is electrically connected to the third node;

a gate electrode of the third transistor is electrically connected to the second driving control terminal, a first electrode of the third transistor is electrically connected to the data line, and a second electrode of the third transistor is electrically connected to the second node;

a gate electrode of the fourth transistor is electrically connected to the second reset control terminal, a first electrode of the fourth transistor is electrically connected to the second initial voltage terminal, and a second electrode of the fourth transistor is electrically connected to the second node;

a gate electrode of the fifth transistor is electrically connected to the second reset control terminal, a first electrode of the fifth transistor is electrically connected to the third initial voltage terminal, and a second electrode of the fifth transistor is electrically connected to the first electrode of the light emitting element.

In at least one embodiment of the present disclosure, the first transistor is a p-type transistor, and the second transistor is an n-type transistor; or,

The first transistor is an n-type transistor, and the second transistor is a p-type transistor.

In at least one embodiment of the present disclosure, the first transistor and the second transistor are both n-type transistors, or, the first transistor and the second transistor are both p-type transistors.

Optionally, the same driving unit included in the driving module provides a first driving control signal for the first driving control terminal and provides a first reset control signal for the first reset control terminal.

In a specific implementation, when the type of the first transistor is the same as the type of the second transistor, that is, when the first transistor and the second transistor are both n-type transistors, or when the first transistor and the second transistor are both p-type transistors, the first driving control signal and the first reset control signal can be provided by the same driving unit included in the driving module.

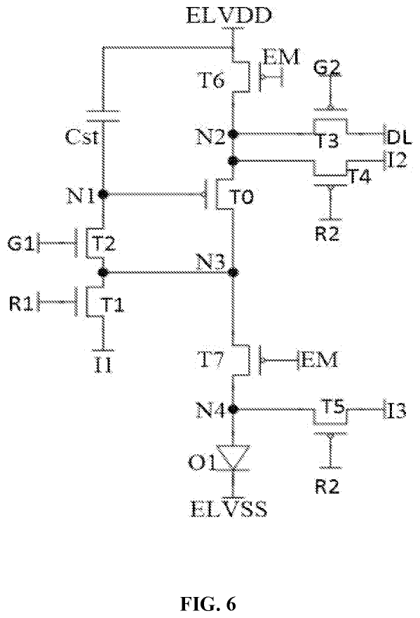

As shown in FIG. 6, based on at least one embodiment of the pixel circuit shown in FIG. 4, the display driving sub-circuit includes a driving transistor TO, the first initialization sub-circuit includes a first transistor T1, the compensation control sub-circuit includes a second transistor T2, the writing-in sub-circuit includes a third transistor T3, the second initialization sub-circuit includes a fourth transistor T4, and the third initialization sub-circuit includes a fifth transistor T5; the light emitting element is an organic light emitting diode O1; at least one embodiment of the pixel circuit further includes a storage capacitor Cst;

The gate electrode of the driving transistor T0 is electrically connected to the first node N1, the source electrode of the driving transistor T0 is electrically connected to the second node N2, and the drain electrode of the driving transistor T0 is electrically connected to the third node N3;

The first terminal of the storage capacitor Cst is electrically connected to the first node N1, and the second terminal of the storage capacitor Cst is electrically connected to the power supply voltage terminal ELVDD;

The gate electrode of the first transistor T1 is electrically connected to the first reset control terminal R1, the source electrode of the first transistor T1 is electrically connected to the first initial voltage terminal I1, and the drain electrode of the first transistor T1 is electrically connected to the third node N3; the first initial voltage terminal I1 is configured to provide the first initial voltage Vi1;

The gate electrode of the second transistor T2 is electrically connected to the first driving control terminal G1, the source electrode of the second transistor T2 is electrically connected to the first node N1, and the drain electrode of the second transistor T2 is electrically connected to the third node N3;

The gate electrode of the third transistor T3 is electrically connected to the second driving control terminal G2, the source electrode of the third transistor T3 is electrically connected to the data line DL, and the drain electrode of the third transistor T3 is electrically connected to the second node N2;

The gate electrode of the fourth transistor T4 is electrically connected to the second reset control terminal R2, the source electrode of the fourth transistor T4 is electrically connected to the second initial voltage terminal 12, and the drain electrode of the fourth transistor T4 is electrically connected to the second node N2; the second initial voltage terminal 12 is configured to provide the second initial voltage Vi2;

The gate electrode of the fifth transistor T5 is electrically connected to the second reset control terminal R2, the source electrode of the fifth transistor T5 is electrically connected to the third initial voltage terminal I3, and the drain electrode of the fifth transistor T5 is electrically connected to the anode of the organic light emitting diode O1;

The first light emitting control sub-circuit includes a sixth transistor T6, and the second light emitting control sub-circuit includes a seventh transistor T7;

The gate electrode of the sixth transistor T6 is electrically connected to the light emitting control terminal EM, the source electrode of the sixth transistor T6 is electrically connected to the power supply voltage terminal ELVDD, and the drain electrode of the sixth transistor is electrically connected to the second node N2;

The gate electrode of the seventh transistor T7 is electrically connected to the light emitting control terminal EM, the source electrode of the seventh transistor T7 is electrically connected to the third node N3, and the drain electrode of the seventh transistor T7 is electrically connected to the anode of the organic light emitting diode O1;

The cathode of the organic light emitting diode O1 is electrically connected to the low voltage terminal ELVSS.

In FIG. 6, the fourth node N4 is electrically connected to the anode of O1.

In at least one embodiment of the pixel circuit shown in FIG. 6, T1 and T2 are n-type transistors, and T0, T3, T4, T5, T6 and T7 are all p-type transistors.

In at least one embodiment of the pixel circuit shown in FIG. 6, the voltage value of the first initial voltage provided by I1 is greater than or equal to −6V and less than or equal to OV, the voltage value of the second initial voltage provided by 12 is greater than or equal to −6V and less than or equal to 0V, and the voltage value of the third initial voltage provided by I3 is greater than or equal to 0V and less than or equal to 10V; but not limited thereto.

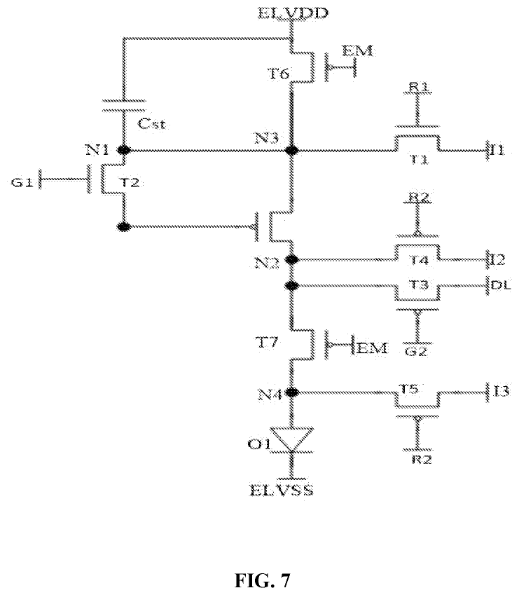

As shown in FIG. 7, based on at least one embodiment of the pixel circuit shown in FIG. 5, the display driving sub-circuit includes a driving transistor TO, the first initialization sub-circuit includes a first transistor T1, the compensation control sub-circuit includes a second transistor T2, the writing-in sub-circuit includes a third transistor T3, the second initialization sub-circuit includes a fourth transistor T4, and the third initialization sub-circuit includes a fifth transistor T5; the light emitting element is an organic light emitting diode O1; at least one embodiment of the pixel circuit further includes a storage capacitor Cst;

The gate electrode of the driving transistor T0 is electrically connected to the first node N1, the source electrode of the driving transistor T0 is electrically connected to the third node N3, and the drain electrode of the driving transistor T0 is electrically connected to the second node N2;

The first terminal of the storage capacitor Cst is electrically connected to the third node N3, and the second terminal of the storage capacitor Cst is electrically connected to the power supply voltage terminal ELVDD;

The gate electrode of the first transistor T1 is electrically connected to the first reset control terminal R1, the source electrode of the first transistor T1 is electrically connected to the first initial voltage terminal I1, and the drain electrode of the first transistor T1 is electrically connected to the third node N3; the first initial voltage terminal I1 is configured to provide the first initial voltage Vi1;

The gate electrode of the second transistor T2 is electrically connected to the first driving control terminal G1, the source electrode of the second transistor T2 is electrically connected to the first node N1, and the drain electrode of the second transistor T2 is electrically connected to the third node N3;

The gate electrode of the third transistor T3 is electrically connected to the second driving control terminal G2, the source electrode of the third transistor T3 is electrically connected to the data line DL, and the drain electrode of the third transistor T3 is electrically connected to the second node N2;

the gate electrode of the fourth transistor T4 is electrically connected to the second reset control terminal R2, the source electrode of the fourth transistor T4 is electrically connected to the second initial voltage terminal 12, and the drain electrode of the fourth transistor T4 is electrically connected to the second node N2; the second initial voltage terminal 12 is configured to provide the second initial voltage Vi2;

the gate electrode of the fifth transistor T5 is electrically connected to the second reset control terminal R2, the source electrode of the fifth transistor T5 is electrically connected to the third initial voltage terminal I3, and the drain electrode of the fifth transistor T5 is electrically connected to the anode of the organic light emitting diode O1, the third initial voltage terminal I3 is configured to provide the third initial voltage Vi3.

The first light emitting control sub-circuit includes a sixth transistor T6, and the second light emitting control sub-circuit includes a seventh transistor T7;

The gate electrode of the sixth transistor T6 is electrically connected to the light emitting control terminal EM, the source electrode of the sixth transistor T6 is electrically connected to the power supply voltage terminal ELVDD, and the drain electrode of the sixth transistor is electrically connected to the third node N3;

The gate electrode of the seventh transistor T7 is electrically connected to the light emitting control terminal EM, the source electrode of the seventh transistor T7 is electrically connected to the second node N2, and the drain electrode of the seventh transistor T7 is electrically connected to the anode of the organic light emitting diode O1;

The cathode of the organic light emitting diode O1 is electrically connected to the low voltage terminal ELVSS.

In FIG. 7, the fourth node N4 is electrically connected to the anode of O1.

In at least one embodiment of the pixel circuit shown in FIG. 7, T1 and T2 are n-type transistors, and T0, T3, T4, T5, T6 and T7 are all p-type transistors.

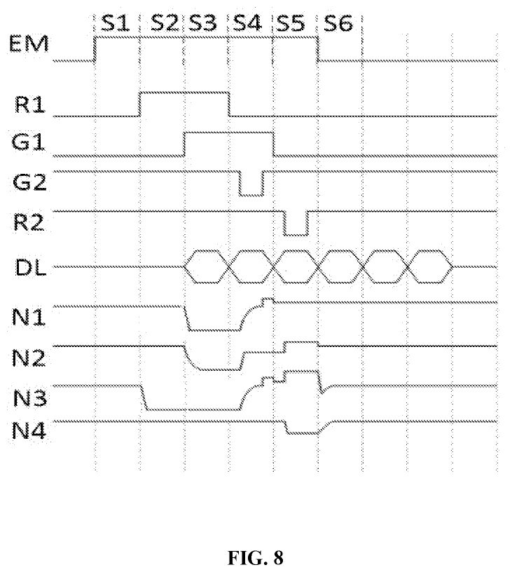

As shown in FIG. 8, when at least one embodiment of the pixel circuit shown in FIG. 6 is in operation, the display period may include a first phase S1, a second phase S2, a third phase S3, a fourth phase S4, a fifth phase S5 and a sixth phase S6 which are successively arranged;

In the first phase S1, EM provides a high voltage signal, R1 provides a low voltage signal, G1 provides a low voltage signal, G2 provides a high voltage signal, and R2 provides a high voltage signal;

In the second phase S2, EM provides a high voltage signal, R1 provides a high voltage signal, G1 provides a low voltage signal, G2 provides a high voltage signal, and R2 provides a high voltage signal, and N3 is connected to the first initial voltage Vi1;

In the third phase S3, EM provides a high voltage signal, R1 provides a high voltage signal, G1 provides a high voltage signal, G2 provides a high voltage signal, and R2 provides a high voltage signal, T1 and T2 are both turned on, NI is connected to the first initial voltage Vi1, and N3 is connected to the first initial voltage Vil, T0 is turned on, and N2 is connected to the first initial voltage Vi1;

In the fourth phase S4, EM provides a high voltage signal, R1 provides a low voltage signal, G1 provides a high voltage signal, G2 provides a low voltage signal, R2 provides a high voltage signal, T2 is turned on, T3 is turned on, DL provides a data voltage Vdata to N2, and charges Cst through Vdata until the potential of N1 becomes Vdata+Vth, where Vth is the threshold voltage of T0;

In the fifth phase S5, EM provides a high voltage signal, R1 provides a low voltage signal, G1 provides a low voltage signal, G2 provides a high voltage signal, R2 provides a low voltage signal, the anode of O1 is connected to Vi3, and N2 is connected to Vi2;

In the sixth phase S6, EM provides a low voltage signal, R1 provides a low voltage signal, G1 provides a low voltage signal, G2 provides a high voltage signal, R2 provides a high voltage signal, T5 and T6 are turned on, and TO drives O1 to emit light.

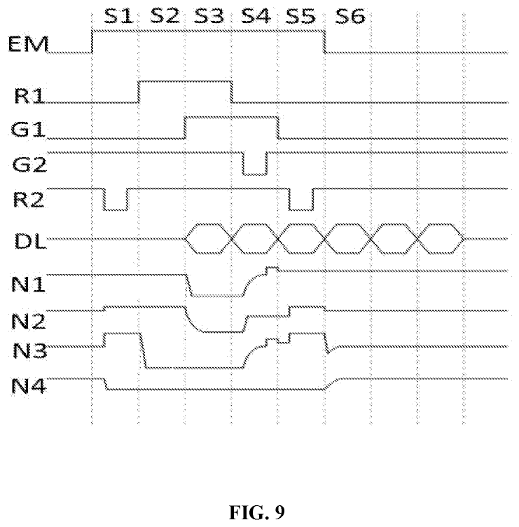

As shown in FIG. 9, when at least one embodiment of the pixel circuit shown in FIG. 6 is working, the display period may include the first phase S1, the second phase S2, the third phase S3, the fourth phase S4, the fifth phase S5 and the sixth phase S6 which are set in sequence;

In the first phase S1, EM provides a high voltage signal, R1 provides a low voltage signal, G1 provides a low voltage signal, G2 provides a high voltage signal, R2 provides a low voltage signal, T4 and T5 are turned on, N2 is connected to Vi2, T0 is turned on, the potential of N3 is Vi2, the gate-source voltage Vgs of T0 is equal to the gate-drain voltage Vgd of T0, Vgs is a relatively large negative voltage, and a strong offset is applied to T0, which can improve the afterimage caused by TFT (thin film transistor) hysteresis, FFR (First Frame Rate) and other defects; T5 is turned on, the anode of O1 is connected to Vi3, and O1 does not emit light;

In the second phase S2, EM provides a high voltage signal, R1 provides a high voltage signal, G1 provides a low voltage signal, G2 provides a high voltage signal, R2 provides a high voltage signal, and N3 is connected to the first initial voltage Vi1;

In the third phase S3, EM provides a high voltage signal, R1 provides a high voltage signal, G1 provides a high voltage signal, G2 provides a high voltage signal, R2 provides a high voltage signal, T1 and T2 are both turned on, N1 is connected to the first initial voltage Vi1, N3 is connected to the first initial voltage Vi1, T0 is turned on, and N2 is connected to the first initial voltage Vi1;

In the fourth phase S4, EM provides a high voltage signal, R1 provides a low voltage signal, G1 provides a high voltage signal, G2 provides a low voltage signal, R2 provides a high voltage signal, T2 is turned on, T3 is turned on, DL provides a data voltage Vdata to N2, and Cst is charged through Vdata until the potential of N1 becomes Vdata+Vth, where Vth is the threshold voltage of T0;

In the fifth phase S5, EM provides a high voltage signal, R1 provides a low voltage signal, G1 provides a low voltage signal, G2 provides a high voltage signal, R2 provides a low voltage signal, the anode of O1 is connected to Vi3, and N2 is connected to Vi2;

In the sixth phase S6, EM provides a low voltage signal, R1 provides a low voltage signal, G1 provides a low voltage signal, G2 provides a high voltage signal, R2 provides a high voltage signal, T5 and T6 are turned on, and T0 drives O1 to emit light.

As shown in FIGS. 8 and 9, the waveform of the first driving control signal is the same as the waveform of the first reset control signal, with only a phase difference. Therefore, the (N−M)th stage of first driving control signal can be reused as the Nth stage of first reset control signal, and both N and M are positive integers.

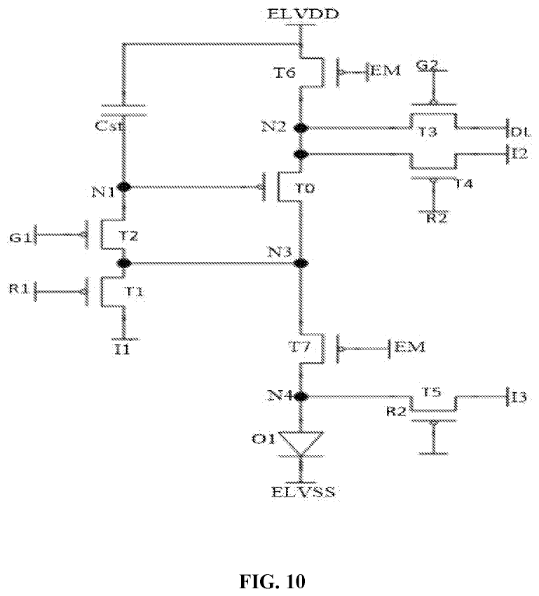

The difference between at least one embodiment of the pixel circuit shown in FIG. 10 and at least one embodiment of the pixel circuit shown in FIG. 6 is that both T1 and T2 are p-type transistors.

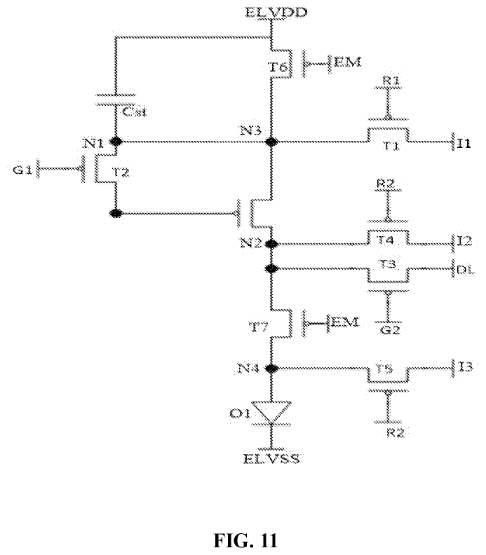

The difference between at least one embodiment of the pixel circuit shown in FIG. 11 and at least one embodiment of the pixel circuit shown in FIG. 7 is that both T1 and T2 are p-type transistors.

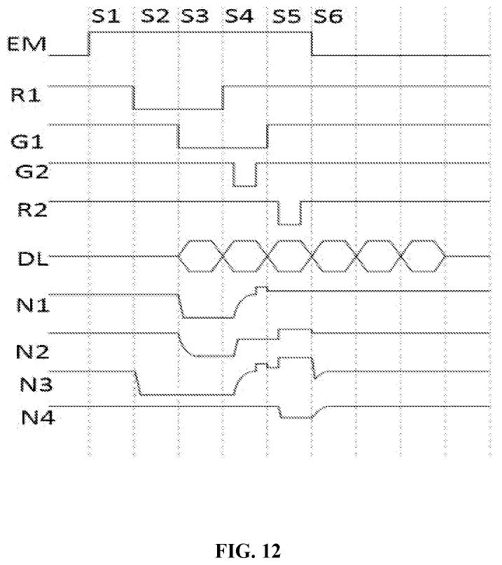

As shown in FIG. 12, when at least one embodiment of the pixel circuit shown in FIG. 10 is in operation, the display period may include a first phase S1, a second phase S2, a third phase S3, a fourth phase S4, a fifth phase S5 and a sixth phase S6 which are successively arranged;

in the first phase S1, EM provides a high voltage signal, R1 provides a high voltage signal, G1 provides a high voltage signal, G2 provides a high voltage signal, and R2 provides a high voltage signal;

in the second phase S2, EM provides a high voltage signal, R1 provides a low voltage signal, G1 provides a high voltage signal, G2 provides a high voltage signal, and R2 provides a high voltage signal, and N3 is connected to the first initial voltage Vi1;

in the third phase S3, EM provides a high voltage signal, R1 provides a low voltage signal, G1 provides a low voltage signal, G2 provides a high voltage signal, and R2 provides a high voltage signal, T1 and T2 are both turned on, N1 is connected to the first initial voltage Vi1, and N3 is connected to the first initial voltage Vi1. Vi1, T0 is turned on, and N2 is connected to the first initial voltage Vi1;

In the fourth phase S4, EM provides a high voltage signal, R1 provides a high voltage signal, G1 provides a low voltage signal, G2 provides a low voltage signal, R2 provides a high voltage signal, T2 is turned on, T3 is turned on, DL provides a data voltage Vdata to N2, and charges Cst through Vdata until the potential of N1 becomes Vdata+Vth, where Vth is the threshold voltage of T0;

In the fifth phase S5, EM provides a high voltage signal, R1 provides a high voltage signal, G1 provides a high voltage signal, G2 provides a high voltage signal, R2 provides a low voltage signal, the anode of O1 is connected to Vi3, and N2 is connected to Vi2;

In the sixth phase S6, EM provides a low voltage signal, R1 provides a high voltage signal, G1 provides a high voltage signal, G2 provides a high voltage signal, R2 provides a high voltage signal, T5 and T6 are turned on, and T0 drives O1 to emit light.

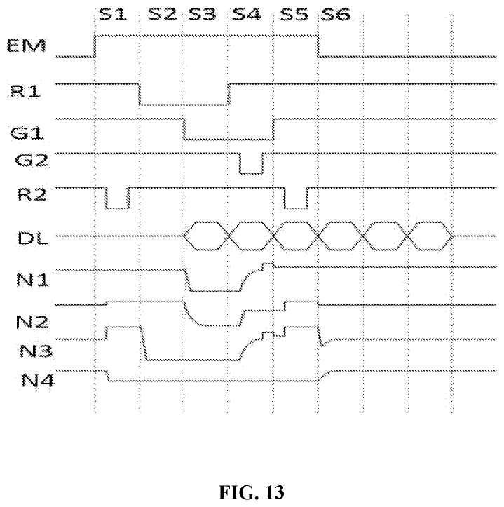

As shown in FIG. 13, when at least one embodiment of the pixel circuit shown in FIG. 10 is in operation, the display period may include the first phase S1, the second phase S2, the third phase S3, the fourth phase S4, the fifth phase S5 and the sixth phase S6 which are successively set;

In the first phase S1, EM provides a high voltage signal, R1 provides a high voltage signal, G1 provides a high voltage signal, G2 provides a high voltage signal, R2 provides a low voltage signal, T4 and T5 are turned on, N2 is connected to Vi2, T0 is turned on, the potential of N3 is Vi2, the gate-source voltage Vgs of T0 is equal to the gate-drain voltage Vgd of T0, Vgs is relatively large negative voltage. Applying a strong offset to T0 can improve the afterimage and FFR caused by TFT (thin film transistor) hysteresis; T5 is turned on, the anode of O1 is connected to Vi3, and O1 does not emit light;

In the second phase S2, EM provides a high voltage signal, R1 provides a low voltage signal, G1 provides a high voltage signal, G2 provides a high voltage signal, R2 provides a high voltage signal, and N3 is connected to the first initial voltage Vi1;

In the third phase S3, EM provides a high voltage signal, R1 provides a low voltage signal, G1 Provides a low voltage signal, G2 provides a high voltage signal, R2 provides a high voltage signal, T1 and T2 are both turned on, N1 is connected to the first initial voltage Vi1, N3 is connected to the first initial voltage Vi1, T0 is turned on, and N2 is connected to the first initial voltage Vi1;

In the fourth phase S4, EM provides a high voltage signal, R1 provides a high voltage signal, G1 provides a low voltage signal, G2 provides a low voltage signal, R2 provides a high voltage signal, T2 is turned on, T3 is turned on, DL provides a data voltage Vdata to N2, and Cst is charged through Vdata until the potential of N1 becomes Vdata+Vth, where Vth is the threshold voltage of T0;

In the fifth phase S5, EM provides a high voltage signal, R1 provides a high voltage signal, G1 provides a high voltage signal, G2 provides a high voltage signal, R2 provides a low voltage signal, the anode of O1 is connected to Vi3, and N2 is connected to Vi2;

In the sixth phase S6, EM provides a low voltage signal, R1 provides a high voltage signal, G1 provides a high voltage signal, G2 provides a high voltage signal, R2 provides a high voltage signal, T5 and T6 are turned on, and T0 drives O1 to emit light.

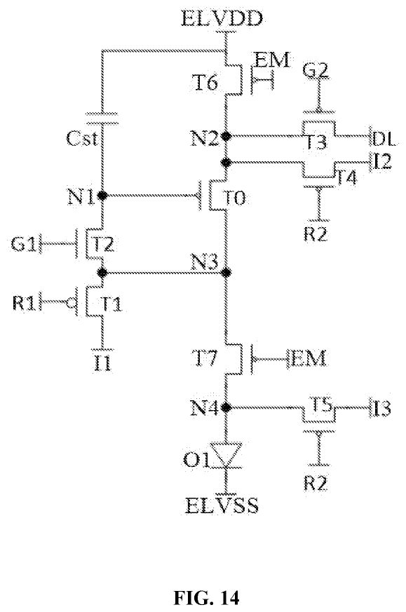

The difference between at least one embodiment of the pixel circuit shown in FIG. 14 and at least one embodiment of the pixel circuit shown in FIG. 6 is that T1 is a p-type transistor.

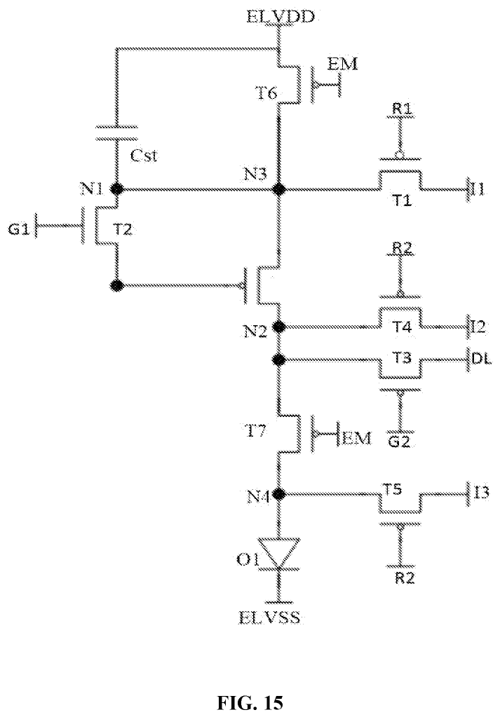

The difference between at least one embodiment of the pixel circuit shown in FIG. 15 and at least one embodiment of the pixel circuit shown in FIG. 7 is that T1 is a p-type transistor.

When at least one embodiment of the pixel circuit shown in FIG. 14 is working, when the pixel circuit needs to refresh the data voltage, G1 needs to be connected to the corresponding first driving control signal, G2 needs to be connected to the corresponding second driving control signal, and R1 needs to be connected to the corresponding first reset control signal; since G1 is usually turned on first and turned off last, it is possible to set a gating unit circuit and a storage unit circuit in the driving unit that generates the first driving control signal, but it is not limited to this.

In at least one embodiment of the present disclosure, the driving module includes two driving units for providing the first driving control signal, and two driving units for providing the second driving control signal;

One driving unit for providing the first driving control signal and One driving unit for providing the second driving control signal are arranged on the first side of the display area;

Another driving unit for providing the first driving control signal and another driving unit for providing the second driving control signal are arranged on the second side of the display area;

The first side and the second side are opposite sides.

In a specific implementation, when the first transistor included in the first initialization sub-circuit and the second transistor included in the compensation control sub-circuit are both n-type transistors or both p-type transistors, the driving unit that provides the first driving control signal can be reused to provide the first reset control signal, so as to reduce the number of driving units, and the bilateral driving of some driving units can be achieved under the premise of reducing the number of groups of driving units, so as to ensure the driving capability, greatly save the frame and power consumption, and improve the image quality.

In at least one embodiment of the present disclosure, the driving unit for providing the first driving control signal and the driving unit for providing the second driving control signal adopt bilateral driving.

Optionally, the display panel also includes a driving unit for providing the second reset control signal, and a driving unit for providing the light emitting control signal;

The driving unit for providing the second reset control signal is arranged on the first side of the display area; the driving unit for providing the light emitting control signal is arranged on the second side of the display area.

In a specific implementation, since the light emitting control signal and the second reset control signal have little effect on the image quality, single-sided driving can be adopted.

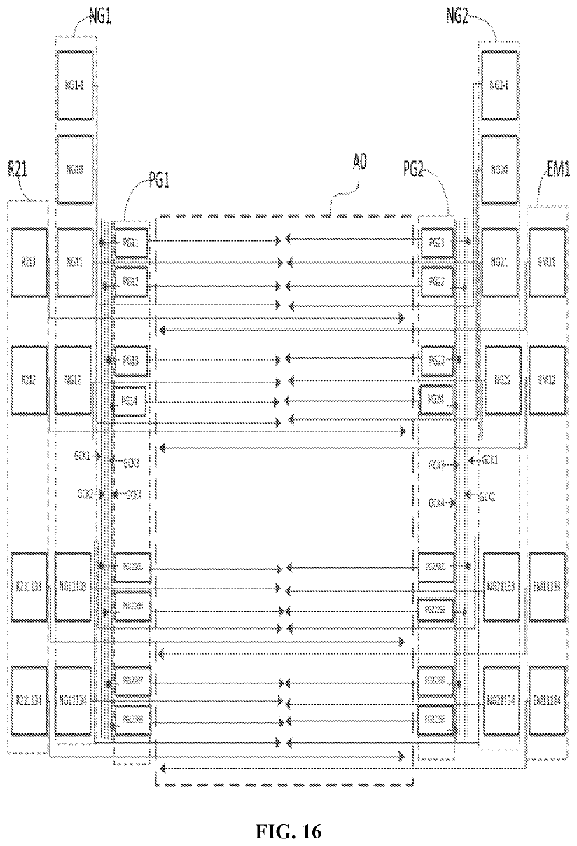

As shown in FIG. 16, the effective display area is labeled A0;

the first driving unit labeled NG1 is configured to provide the first driving control signal, and the second driving unit labeled NG2 is configured to provide the first driving control signal;

the third driving unit labeled PG1 is configured to provide the second driving control signal, and the fourth driving unit labeled PG2 is configured to provide the second driving control signal;

the fifth driving unit labeled EM1 is configured to provide the light emitting control signal, and the sixth driving unit labeled R21 is configured to provide the second reset control signal;

NG1, R21 and PG1 are arranged on the left side of A0; NG2, PG2 and EM1 are arranged on the right side of A0.

The first stage of driving circuit of NG1 is labeled NG11, the second stage of driving circuit of NG1 is labeled NG 12, the 1133rd stage of driving circuit of NG1 is labeled NG 11133, and the 1134^{th} stage of driving circuit of NG1 is labeled NG 11134;

The driving circuit for providing the second reset control signal of NG1 is labeled NG10, and the driving circuit for providing the first reset control signal of NG1 is labeled NG1-1;

The first stage of driving circuit of PG1 is labeled PG11, the second stage of driving circuit of PG1 is labeled PG12, the third stage of driving circuit of PG1 is labeled PG13, and the fourth stage of driving circuit of PG1 is labeled PG 14, PG 12265 is the 2265th stage of driving circuit included in PG1, PG 12266 is the 2266th stage of driving circuit included in PG1, PG 12267 is the 2267th stage of driving circuit included in PG 1, and PG 12268 is the 2268th stage of driving circuit included in PG1;

R211 is the first stage of driving circuit included in R21, R212 is the second stage of driving circuit included in R21, R211133 is the 1133^{th} stage of driving circuit included in R21, and R211134 is the 1134^{th} stage of driving circuit included in R21;

NG21 is the first stage of driving circuit included in NG2, NG22 is the second stage of driving circuit included in NG2, NG 21133 is the 1133^{rd} stage of driving circuit included in NG2, and NG21134 is the 1134^{th} stage of driving circuit included in NG2;

NG20 is the driving circuit for providing the second stage of first reset control signal included in NG2, and NG2-1 is the driving circuit for providing the first stage of first reset control signal included in NG2;

PG21 is the first stage of driving circuit included in PG2, PG22 is the second stage of driving circuit included in PG2, and PG23 is the third stage of driving circuit included in PG2, P24 is the fourth stage of driving circuit included in PG2, PG22265 is the 2265^{th} stage of driving circuit included in PG2, PG22266 is the 2266th stage of driving circuit included in PG2, PG22267 is the 2267^{th} stage of driving circuit included in PG2, PG22268 is the 2268^{th} stage of driving circuit included in PG2;

The first stage of driving circuit included in EM1 is labeled EM11, the second stage of driving circuit included in EM1 is labeled EM12, the 1133^{rd} stage of driving circuit included in EM1 is labeled EM11233, and the 1134^{th} stage of driving circuit included in EM1 is labeled EM11134.

In FIG. 16, the first clock signal is labeled GCK1, the second clock signal is labeled GCK2, the third clock signal is labeled GCK3, and the fourth clock signal is labeled GCK4.

In at least one embodiment shown in FIG. 16, M is equal to 2.

In at least one embodiment shown in FIG. 16, the first stage of driving circuit included in NG1 provides a first driving control signal for two adjacent rows of pixel circuits, and the first stage of driving circuit included in NG2 provides a first driving control signal for two adjacent rows of pixel circuits;

One stage of driving circuit included in PG1 provides a first driving control signal for one row of pixel circuits, and one stage of driving circuit included in PG2 provides a first driving control signal for one row of pixel circuits;

One stage of driving circuit included in R21 provides a second reset control signal for two adjacent rows of pixel circuits;

One stage of driving circuit included in EM1 provides a light emitting control signal for two adjacent rows of pixel circuits.

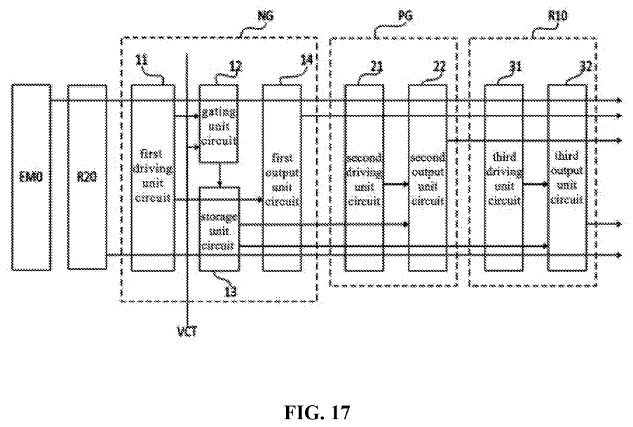

As shown in FIG. 17, the driving unit labeled NG is configured to provide the first driving control signal;

The driving unit labeled PG is configured to provide the second driving control signal;

The driving unit labeled EMO is configured to provide the light emitting control signal;

The driving unit labeled R20 is configured to provide the second reset control signal;

The driving unit labeled R10 is configured to provide the first reset control signal;

The driving unit NG for providing the first driving control signal includes a first driving unit circuit 11, a gating unit circuit 12, a storage unit circuit 13 and a first output unit circuit 14;

The driving unit PG for providing the second driving control signal includes a second driving unit circuit 21 and a second output unit circuit 22;

The driving unit R10 for providing the first reset control signal includes a third driving unit circuit 31 and a third output unit circuit 32;

The first driving unit circuit 11 is configured to provide a first driving control signal;

The gating unit circuit 12 is electrically connected to the first driving unit circuit 11 and the gating input signal terminal VCT respectively, and is configured to provide a gating control signal according to the first driving signal and the gating input signal provided by the gating input signal terminal VCT;

The storage unit circuit 13 is connected to the gating unit circuit 12 and configured to store the gating control signal;

The first output unit circuit 14 is electrically connected to the first driving unit circuit 11 and the storage unit circuit 13 respectively, and is configured to receive the gating control signal from the storage unit circuit 13, and control whether to output the first driving control signal to the pixel circuit in the current display period according to the gating control signal;

The second driving unit circuit 21 is configured to provide a second driving control signal;

The second output unit circuit 22 is electrically connected to the second driving unit circuit 21 and the storage unit circuit 13 respectively, and is configured to receive the gating control signal from the storage unit circuit 13, and control whether to output the second driving control signal to the pixel circuit in the current display period according to the gating control signal;

The third driving unit circuit 31 is configured to provide a first reset control signal;

The third output unit circuit 32 is electrically connected to the third driving unit circuit 31 and the storage unit circuit 13 respectively, and is configured to receive the gating control signal from the storage unit circuit 13, and control whether to output the first reset control signal to the pixel circuit in the current display period according to the gating control signal.

In at least one embodiment of the present disclosure, the display panel includes a first driving module and a second driving module;

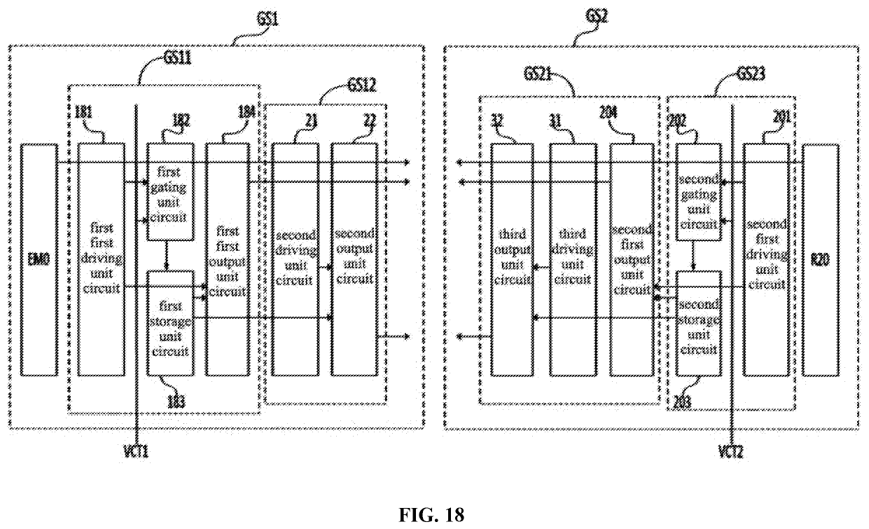

As shown in FIG. 18, the first driving module GS1 is arranged on the left side of the display panel, and the second driving module GS2 is arranged on the right side of the display panel;

The first driving module includes a first first driving unit GS11 and a second driving unit GS12, and the second driving module includes a second first driving unit GS21 and a third driving unit GS23;

The first first driving unit GS11 is configured to control the output of a first driving control signal;

The second first driving unit GS21 is configured to control the output of a first reset control signal;

The second driving unit GS12 is configured to provide a first second driving control signal; and the third driving unit is configured to control the output of a second second driving signal.

The first first driving unit GS11 includes a first first driving unit circuit 181, a first gating unit circuit 182, a first storage unit circuit 183 and a first first output unit circuit 184;

The first first driving unit circuit 181 is configured to provide a first driving control signal;

The first gating unit circuit 182 is electrically connected to the first first driving unit circuit 181 and the first gating input signal terminal VCT1, respectively, and is configured to provide a first gating control signal according to the first driving control signal and the first gating input signal provided by the first gating input signal terminal VCT1;

The first storage unit circuit 183 is electrically connected to the first gating unit circuit 182, and is configured to store the first gating control signal;

The first first output unit circuit 184 is electrically connected to the first storage unit circuit 183 and the first first driving unit circuit 181 respectively, and is configured to control whether to output the first control driving signal to the pixel circuit in the current display period according to the first gating control signal;

The second driving unit GS12 includes a second driving unit circuit 21 and a second output unit circuit 1922;

The second driving unit circuit 21 is configured to provide a first second driving control signal;

The second output unit circuit 22 is electrically connected to the second driving unit circuit 21, and is configured to control whether to output the first second driving control signal to the pixel circuit in the current display period according to the first gating control signal;

The second first driving unit includes a second first driving unit circuit 201, a second gating unit circuit 202, a second storage unit circuit 203 and a second first output unit circuit 204;

The second first driving unit circuit 201 is configured to provide a first reset control signal;

The second gating unit circuit 202 is electrically connected to the second first driving unit circuit 201 and the second gating input signal terminal VCT2, respectively, and is configured to provide a second gating control signal according to the first reset control signal and the second gating input signal provided by the second gating input signal terminal VCT2;

The second storage unit circuit 203 is electrically connected to the second gating unit circuit 202, and is configured to store the second gating control signal;

The second first output unit circuit 204 is electrically connected to the second storage unit circuit 203 and the second first driving unit circuit 201 respectively, and is configured to control whether to output the first reset control signal to the pixel circuit in the current display period according to the second gating control signal;

The third driving unit includes a third driving unit circuit 31 and a third output unit circuit 32;

The third driving unit circuit 31 is configured to provide a second second driving control signal;

The third output unit circuit 32 is electrically connected to the second storage unit circuit 203 and the third driving unit circuit 31 respectively, and is configured to control whether to output the second second driving control signal to the pixel circuit in the current display period according to the second gating control signal.

In at least one embodiment shown in FIG. 18, the driving unit labeled EM0 is configured to provide a light emitting control signal, and EMO is arranged on the left side of the display panel;

The driving unit labeled R20 is configured to provide a second reset control signal, and R20 is arranged on the right side of the display panel.

The display device described in the embodiment of the present disclosure includes the above-mentioned display panel.

The above descriptions are implementations of the present disclosure. It should be pointed out that those skilled in the art can make some improvements and modifications without departing from the principle of the present disclosure. These improvements and modifications shall also fall within the scope of the present disclosure.

1. A driving module, included in a display panel and for providing a driving signal for a pixel circuit in the display panel; wherein the driving module includes N driving units, N is an integer greater than 1;
a first driving unit includes a first driving unit circuit, a gating unit circuit and a first output unit circuit;
the first driving unit circuit is configured to provide a first driving signal;
the gating unit circuit is electrically connected to the first driving unit circuit and a gating input signal terminal respectively, and is configured to provide a gating control signal according to the first driving signal and a gating input signal provided by the gating input signal terminal;
the first output unit circuit is electrically connected to the first driving unit circuit, and is configured to control whether to output the first driving signal to the pixel circuit in a current display period according to the gating control signal;
an nth driving unit includes an nth driving unit circuit and an nth output unit circuit, n is an integer greater than 1 and less than or equal to N;
the nth driving unit circuit is configured to provide an nth driving signal;
an nth output unit circuit is electrically connected to the nth driving unit circuit, and is configured to control whether to output the nth driving signal to the pixel circuit in the current display period according to the gating control signal.

2. The driving module according to claim 1, wherein the first driving unit further comprises a storage unit circuit;
the storage unit circuit is electrically connected to the gating unit circuit and configured to store the gating control signal;
the first output unit circuit and the nth output unit circuit are also electrically connected to the storage unit circuit, is configured to receive the gating control signal.

3. The driving module according to claim 2, wherein the first driving unit circuit includes M stages of first driving circuits, and an mth stage of first driving circuit is configured to provide an mth stage of first driving signal; M is an integer greater than 1; m is a positive integer less than or equal to M;
the gating unit circuit includes M gating circuits; the first output unit circuit includes M first output circuits;
an mth gating circuit is electrically connected to the mth stage of first driving circuit and the gating input signal terminal, respectively, and is configured to provide an mth gating control signal according to the mth stage of first driving signal provided by the mth stage of first driving circuit and the gating input signal provided by the gating input signal terminal;
an mth first output circuit is electrically connected to the mth stage of first driving circuit, configured to control whether to output the mth stage of first driving signal to the pixel circuit in the current display period according to the mth gating control signal;
the nth driving unit includes an nth driving unit circuit and an nth output unit circuit, n is an integer greater than 1 and less than or equal to N;
the nth driving unit circuit includes M stages of nth driving circuits, and an mth stage of nth driving circuit is configured to provide an mth stage of nth driving signal;
the nth output unit circuit includes M nth output circuits;
an mth nth output circuit is electrically connected to the mth stage of nth driving circuit, and is configured to control whether to output the mth stage of nth driving signal to the pixel circuit in the current display period according to the mth gating control signal.

4. The driving module according to claim 3, wherein the storage unit circuit includes M storage circuits;
an mth storage circuit is electrically connected to the mth gating circuit, is configured to store the mth gating control signal;
an mth first output circuit and an mth nth output circuit are also electrically connected to the mth storage circuit, is configured to receive the mth gating control signal.

5. A display panel, comprising a pixel circuit and a driving module according to claim 1; wherein
the pixel circuit is arranged in the display area.

6. The display panel according to claim 5, wherein the driving module is arranged on a first side or a second side of the display area;
the first side and the second side are opposite sides.

7. The display panel according to claim 5, wherein the display panel comprises a first driving module and a second driving module;
the first driving module is arranged on a first side of the display panel, and the second driving module is arranged on a second side of the display panel;
the first side and the second side are opposite sides.

8. The display panel according to claim 7, wherein the first driving module includes a first first driving unit and a second driving unit, and the second driving module includes a second first driving unit and a third driving unit;
the first first driving unit is configured to control to output a first first driving signal;
the second first driving unit is configured to control to output a second first driving signal;
the second driving unit is configured to provide a second driving signal; and the third driving unit is configured to control to output a third driving signal.

9. The display panel according to claim 8, wherein the first first driving unit includes a first first driving unit circuit, a first gating unit circuit and a first first output unit circuit;
the first first driving unit circuit is configured to provide a first first driving signal;
the first gating unit circuit is electrically connected to the first first driving unit circuit and the first gating input signal terminal respectively, and is configured to provide a first gating control signal according to the first first driving signal and the first gating input signal provided by the first gating input signal terminal;
the first first output unit circuit is electrically connected to the first first driving unit circuit, and is configured to control whether to output the first first driving signal to the pixel circuit in the current display period according to the first gating control signal;
the second driving unit includes a second driving unit circuit and a second output unit circuit;
the second driving unit circuit is configured to provide a second driving signal;
the second output unit circuit is electrically connected to the second driving unit circuit, and is configured to control whether to output the second driving signal to the pixel circuit in the current display period according to the first gating control signal.

10. The display panel according to claim 9, wherein the first first driving unit further includes a first storage unit circuit;
the first storage unit circuit is electrically connected to the first gating unit circuit and configured to store the first gating control signal;
the second output unit circuit is electrically connected to the first storage unit circuit and configured to receive the first gating control signal.

11. The display panel according to claim 8, wherein the second first driving unit includes a second first driving unit circuit, a second gating unit circuit and a second first output unit circuit;
the second first driving unit circuit is configured to provide a second first driving signal;
the second gating unit circuit is electrically connected to the second first driving unit circuit and the second gating input signal terminal respectively, and is configured to provide a second gating control signal according to the second first driving signal and the second gating input signal provided by the second gating input signal terminal;
the second first output unit circuit is electrically connected to the second first driving unit circuit, and is configured to control whether to output the second first driving signal to the pixel circuit in the current display period according to the second gating control signal;
the third driving unit includes a third driving unit circuit and a third output unit circuit;
the third driving unit circuit is configured to provide a third driving signal;
the third output unit circuit is electrically connected to the third driving unit circuit, and is configured to control whether to output the third driving signal to the pixel circuit in the current display period according to the second gating control signal;
wherein the second first driving unit further includes a second storage unit circuit;
the second storage unit circuit is electrically connected to the second gating unit circuit and configured to store the second gating control signal;
the third output unit circuit is electrically connected to the second storage unit circuit and configured to receive the second gating control signal.

12. (canceled)

13. The display panel according to claim 5, wherein the pixel circuit includes a light emitting element, a display driving sub-circuit, a compensation control sub-circuit, a writing-in sub-circuit, a first initialization sub-circuit, a second initialization sub-circuit and a third initialization sub-circuit;
a control terminal of the display driving sub-circuit is electrically connected to a first node, a first terminal of the display driving sub-circuit is electrically connected to a second node, and a second terminal of the display driving sub-circuit is electrically connected to a third node;
the compensation control sub-circuit is electrically connected to the first driving control terminal, the first node and the third node respectively, and is configured to control to connect the first node and the third node under the control of the first driving control signal provided by the first driving control terminal;
the writing-in sub-circuit is electrically connected to the second driving control terminal, the data line and the second node respectively, and is configured to write the data voltage provided by the data line into the second node under the control of the second driving control signal provided by the second driving control terminal;
the first initialization sub-circuit is electrically connected to the first reset control terminal, the first initial voltage terminal and the third node respectively, and is configured to write the first initial voltage provided by the first initial voltage terminal into the third node under the control of the first reset control signal provided by the first reset control terminal;
the second initialization sub-circuit is electrically connected to the second reset control terminal, the second initial voltage terminal and the second node respectively, and is configured to write the second initial voltage provided by the second initial voltage terminal into the second node under the control of the second reset control signal provided by the second reset control terminal;
the third initialization sub-circuit is electrically connected to the second reset control terminal, the third initial voltage terminal and the first electrode of the light emitting element respectively, and is configured to write the third initial voltage provided by the third initial voltage terminal into a first electrode of the light emitting element under the control of the second reset control signal;
a second electrode of the light emitting element is electrically connected to the first voltage terminal.

14. The display panel according to claim 13, wherein the second initialization sub-circuit is configured to control to write the second initial voltage into the second node before the first initialization sub-circuit writes the first initial voltage provided by the first initial voltage terminal into the third node and the compensation control sub-circuit controls to connect the first node and the third node under the control of the second reset control signal;
the third initialization sub-circuit is configured to control to write the third initial voltage into the first electrode of the light emitting element before the first initialization sub-circuit writes the first initial voltage provided by the first initial voltage terminal into the third node and the compensation control sub-circuit controls to connect the first node and the third node under the control of the second reset control signal.

15. The display panel according to claim 13, wherein the pixel circuit further includes a first light emitting control sub-circuit and a second light emitting control sub-circuit;
the first light emitting control sub-circuit is electrically connected to a light emitting control terminal, a power supply voltage terminal and the second node respectively, and is configured to control to connect the power supply voltage terminal and the second node under the control of a light emitting control signal provided by the light emitting control terminal; the second light emitting control sub-circuit is electrically connected to the light emitting control terminal, the third node and the first electrode of the light emitting element respectively, and is configured to control to connect the third node and the first electrode of the light emitting element under the control of the light emitting control signal; or,
the first light emitting control sub-circuit is electrically connected to the light emitting control terminal, the power supply voltage terminal and the third node respectively, and is configured to control to connect the power supply voltage terminal and the third node under the control of the light emitting control signal provided by the light emitting control terminal; the second light emitting control sub-circuit is electrically connected to the light emitting control terminal, the second node and the first electrode of the light emitting element respectively, and is configured to control to connect the second node and the first electrode of the light emitting element under the control of the light emitting control signal.

16. The display panel according to claim 13, wherein the display driving sub-circuit includes a driving transistor, the first initialization sub-circuit includes a first transistor, the compensation control sub-circuit includes a second transistor, the writing-in sub-circuit includes a third transistor, the second initialization sub-circuit includes a fourth transistor, and the third initialization sub-circuit includes a fifth transistor;
a gate electrode of the driving transistor is electrically connected to the first node, a first electrode of the driving transistor is electrically connected to the second node, and a second electrode of the driving transistor is electrically connected to the third node;
a gate electrode of the first transistor is electrically connected to the first reset control terminal, a first electrode of the first transistor is electrically connected to the first initial voltage terminal, and a second electrode of the first transistor is electrically connected to the third node;
a gate electrode of the second transistor is electrically connected to the first driving control terminal, a first electrode of the second transistor is electrically connected to the first node, and a second electrode of the second transistor is electrically connected to the third node;
a gate electrode of the third transistor is electrically connected to the second driving control terminal, a first electrode of the third transistor is electrically connected to the data line, and a second electrode of the third transistor is electrically connected to the second node;
a gate electrode of the fourth transistor is electrically connected to the second reset control terminal, a first electrode of the fourth transistor is electrically connected to the second initial voltage terminal, and a second electrode of the fourth transistor is electrically connected to the second node;
a gate electrode of the fifth transistor is electrically connected to the second reset control terminal, a first electrode of the fifth transistor is electrically connected to the third initial voltage terminal, and a second electrode of the fifth transistor is electrically connected to the first electrode of the light emitting element.

17. The display panel according to claim 16, wherein the first transistor is a p-type transistor and the second transistor is an n-type transistor; or, the first transistor is an n-type transistor and the second transistor is a p-type transistor.

18. The display panel according to claim 16, wherein the first transistor and the second transistor are both n-type transistors, or, the first transistor and the second transistor are both p-type transistors.

19. The display panel according to claim 18, wherein a same driving unit included in the driving module provides a first driving control signal for the first driving control terminal and provides a first reset control signal for the first reset control terminal.

20. The display panel according to claim 19, wherein the driving module includes two driving units for providing the first driving control signal, and two driving units for providing the second driving control signal;
one driving unit for providing the first driving control signal and one driving unit for providing the second driving control signal are arranged on a first side of the display area;
the other driving unit for providing the first driving control signal and the other driving unit for providing the second driving control signal are arranged on a second side of the display area;
the first side and the second side are opposite sides; or
wherein the display panel further includes a driving unit for providing the second reset control signal, and a driving unit for providing the light emitting control signal;
the driving unit for providing the second reset control signal is arranged on a first side of the display area; the driving unit for providing the light emitting control signal is arranged on a second side of the display area.

21. (canceled)

22. A display device comprising the display panel according to claim 5.
